(19) United States
(12) Patent Application Publication
(10) Pub. No.: US 2009/0296660 A1
(43) Pub. Date: Dec. 3, 2009

(54) METHOD, GENERIC ACCESS NETWORK CONTROLLER AND TERMINAL FOR DUAL TRANSFER MODE HANDOVER

(76) Inventor: Wulin WENG, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/537,635

(22) Filed: Aug. 7, 2009

Related U.S. Application Data
(63) Continuation of application No. PCT/CN2008/070275, filed on Feb. 4, 2008.

(30) Foreign Application Priority Data
Feb. 9, 2007 (CN) 200710079021.7

(51) Int. Cl. H04W 36/00

(52) U.S. Cl. 370/332; 370/331

(57) ABSTRACT

A Dual Transfer Method (DTM) handover method is provided. The provided method creates a user data link applicable to both the CS domain and PS domain for the terminal, and handles the handover procedure of the CS domain and PS domain related to the same terminal, thus enhancing the network capability and QoS. A Generic Access Network Controller (GANC) and a user terminal are also provided. Consistent with the provided method, GANC, and user terminal, a mobile terminal that performs the CS domain service and PS domain service concurrently may roam freely on a radio CN through different access technologies, thus improving the mobility and service experience of the users.

This application is a continuation of International Application No. PCT/CN2008/070275, filed on Feb. 4, 2008, which claims the priority of CN application No. 200710079021.7 filed on Feb. 9, 2007, entitled “Method and Generic Access Network Controller for Dual Transfer Mode Handover”, the contents of which are all incorporated herein by reference in their entireties.

### TECHNICAL FIELD

This present disclosure relates to mobile communication technologies, and in particular, to a method, Generic Access Network Controller (GANC), and user terminal for Dual Transfer Mode (DTM) handover.

### BACKGROUND

In a mobile communication network, an access network serves as a bridge between the terminal user and the core switching network, and its communication capability is directly critical to the effect of the user experiencing the mobile service. With the development of the short-distance radio communication technologies, the access network is more and more important by virtue of high access bandwidth and low communication costs. It is popularized rapidly to provide radio access at the unlicensed band based on the short-distance radio communication technologies. Such a radio access mode coexists with the traditional radio access network within the local area or even metropolitan area. Therefore, the seamless handover and roaming between the traditional radio access network and the Generic Access Network (GAN) based on Unlicensed Mobile Access (UMA) become an attention-attracting technology, where the traditional radio access network may be a Universal Mobile Telecommunications System (UMTS) Terrestrial Radio Access Network (UTRAN), Global System for Mobile communications (GSM), or the GSM Enhanced Data rate for GSM Evolution (EDGE) Radio Access Network (GERAN).

In a GAN, the mobile terminal is connected to a GANC through a generic access IP network to communicate, where the GANC is equivalent to the Base Station Subsystem (BSS) of a GERAN cell and the generic access IP network provides radio access points. In the whole radio network, the GANC is generally configured as a cell within a routing area or location area, thus implementing handover and roaming between the GAN and other access networks.

Currently, the terminal that supports the GAN is already capable of performing Circuit Switched (CS) domain or Packet Switched (PS) domain service handover independently between a GAN and a cell that adopts other access networks. For example, when a terminal under a CS or PS service in the GAN discovers that the link quality is deteriorated and reaches the condition of triggering handover, the terminal may hand over to other access network cells configured as neighboring cells, for example, a GERAN cell. Likewise, when the terminal under a CS or PS service in the GERAN discovers that the GAN link quality is good and reaches the condition of triggering handover, the terminal may also hand over to the GAN cell. However, the prior art suffers from at least the following problems: When the terminal performs both CS service and PS service in the GERAN or UTRAN simultaneously, namely, the terminal is in a DTM state, if the terminal needs to hand over to the GAN, no solution to handover is provided in the prior art. Possible consequences are: The handover fails; or only the CS handover is performed but the PS service is suspended; or only the PS handover is performed but the CS service is suspended. Regardless of the consequence, the Quality of Service (QoS) is impaired, and the user experience is deteriorated.

### SUMMARY

Some embodiments of the present disclosure put forward a DTM handover method, a GANC, and a user terminal to set up user data links applicable to both the CS domain and the PS domain for the terminal and handle the handover procedures of the CS domain and PS domain related to the same terminal, with a view to enhancing the network capabilities and QoS.

A DTM handover method provided in an embodiment of the present disclosure includes:

receiving, handover information from a terminal in a Dual Transfer Mode (DTM), wherein the handover information specifies a target Generic Access Network (GAN) cell;

sending, handover preparation request information of a Packet Switched (PS) domain and a Circuit Switched (CS) domain to the target GAN cell;

receiving, handover preparation result information of the PS domain and the CS domain from the target GAN cell in response to the handover preparation request information; and

sending a handover command to the terminal.

Another Dual Transfer Mode (DTM) handover method is provided in an embodiment of the present disclosure includes:
sending, by a Generic Access Network Controller (GANC) handover preparation request information of a Packet Switched (PS) domain and a Circuit Switched (CS) domain to a Radio Access Network (RAN) where at least one selected target cell is located when it is necessary to perform PS domain and CS domain handover for a terminal;
receiving, by the GANC, handover preparation result information from the RAN; and
sending a handover command to the terminal in response to the handover preparation result information.

Another Dual Transfer Mode (DTM) handover method provided in an embodiment of the present disclosure includes:
receiving handover preparation request information of a Packet Switched (PS) domain and a Circuit Switched (CS) domain for a terminal from a source Radio Access Technology (RAT) cell where the terminal is located;
creating, by a Generic Access Network (GAN) cell, a user data link applicable to the CS domain and the PS domain for the terminal in response to the handover preparation request information; and
sending, by the GAN cell, handover preparation result information of the PS domain and the CS domain for the terminal to the source RAT cell.

In addition, a GANC provided in an embodiment of the present disclosure includes:

a transferring unit, adapted to provide a terminal with a user data link applicable to a Circuit Switched (CS) domain and a Packet Switched (PS) domain;

a dual-mode control unit, adapted to control the transferring unit to create or release user data links applicable to a PS domain and a CS domain for the same terminal according to the indication of a handover control unit; and

a handover control unit, which includes an incoming handover control unit and an outgoing handover control unit.

The incoming handover control unit is configured to: receive the handover preparation request information of the PS domain and CS domain of the same terminal from the Core Network (CN); instruct the dual-mode control unit to create the user data links applicable to the PS domain and CS domain for the terminal; and return the handover preparation result information to the CN.

The outgoing handover control unit is adapted to: send handover preparation request information of the PS domain and CS domain to the CN when the terminal needs to perform PS domain and CS domain handover; and receive the handover preparation result information returned by the CN, and send a handover command to the terminal.

A user terminal provided in an embodiment of the present disclosure includes:

a handover information sending unit, adapted to send handover information to the network, where the handover information specifies a target cell;

a command receiving unit, adapted to receive the handover command from the network; and

a handover unit, adapted to hand over the PS domain service and CS domain service to the created user data links of the PS domain and CS domain according to the handover command.

Some embodiments of the present disclosure may create user data links applicable to the CS domain and PS domain concurrently for the terminal, and handle the handover procedures of the CS domain and PS domain related to the same terminal. Therefore, a mobile terminal that performs the CS domain service and PS domain service concurrently may roam freely on a radio CN through different access technologies, thus improving the mobility and service experience of the users.

### BRIEF DESCRIPTION OF THE DRAWINGS

FIG. 1 is a flowchart of a method for DTM handover in a first embodiment.

FIG. 2 is a signaling flowchart of a method in the first embodiment.

FIG. 3 is a flowchart of a method for DTM handover in a second embodiment.

FIG. 4 is a flowchart of a method for DTM handover in a third embodiment.

FIG. 5 is a flowchart of a method for DTM handover in a fourth embodiment.

FIG. 6 is a flowchart of a method for DTM handover in a fifth embodiment.

FIG. 7 is a signaling flowchart of a method in the fifth embodiment.

FIG. 8 is a flowchart of a method for DTM handover in a sixth embodiment.

FIG. 9 is a flowchart of a method for DTM handover in a seventh embodiment.

FIG. 10 is a flowchart of a DTM handover method for handover from other access networks to a GAN in Iu mode in an eighth embodiment.

FIG. 11 is a flowchart of a DTM handover method for handover from a GAN in Iu mode to other access networks in a ninth embodiment.

FIG. 12 shows a structure of a GANC in the eighth embodiment.

FIG. 13 shows a structure of a GANC in the ninth embodiment.

FIG. 14 shows a structure of a GANC in a tenth embodiment.

FIG. 15 shows a structure of a GANC in an eleventh embodiment.

The embodiments of the present disclosure are hereinafter described in detail by reference to accompanying drawings.

### DETAILED DESCRIPTION

The embodiments of the present disclosure provide a GAN DTM handover method. The GANC creates user data links applicable to the CS domain and PS domain concurrently for the terminal, and performs handover for the CS service and PS service of the same terminal, where the user data links include Generic Access Circuit Switched Resource (GA-CSR) connection and Generic Access Packet Switched Resource (GA-PSR) transport channel, and the handover includes handover into a GAN and handover out of a GAN. A GANC applicable to the foregoing GAN DTM handover method is also provided herein. The method and devices provided herein are detailed below.

### Embodiment 1

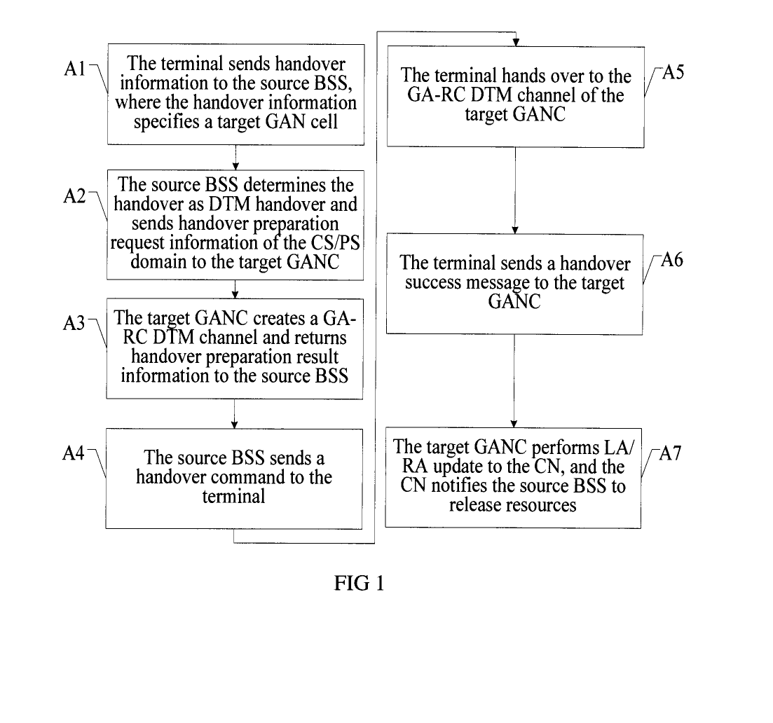

A method of DTM handover from another access network based on the Radio Access Technology (RAT) to the GAN is provided in this embodiment. The other access network may be a GERAN or UTRAN, and is supposed to be a GERAN in this embodiment. As shown in FIG. 1, the method includes the following steps:

A1. The terminal sends handover information to a source RAN. In a GERAN or UTRAN, the source RAN is a BSS. The handover information specifies the target GAN cell of the handover.

When the mobile station that supports the GAN is in a GERAN cell, the mobile station attempts to discover the GAN continuously. Once a GAN network service is found, the mobile station performs registration to the GANC. After the mobile station is registered on a GANC successfully, the handover from the GERAN to the GAN is generally triggered by discovery of a GAN if the GAN is preferred. If the GERAN or UTRAN is preferred, the handover may be triggered by deterioration of the channel quality of the current GERAN cell. The terminal in this embodiment is under the CS domain service and the PS domain service (namely, in the DTM state) concurrently. Therefore, the terminal in the GERAN may implement performance measurement for the timeslot used by either or both of the CS service and PS service to judge whether handover is initiated.

A terminal notifies a source BSS to hand over to a GAN cell in either of the following modes:

(i) If the GAN cell where the terminal is registered is covered in the neighboring cell list of the GERAN cell where the terminal is currently located, the terminal may send a cell measurement report as handover information to the source BSS. In the cell measurement report, the preferred cell is the GAN cell where the terminal is registered. According to the measurement report, the source BSS determines it necessary to hand over from the GERAN cell to the GAN cell.

(ii) The terminal may also send a Packet Cell Change Notification (PCCN) message as handover information to the source BSS directly. The message carries a target GAN cell where the terminal is registered, and this target GAN cell serves as a candidate cell. According to the PCCN message, the source BSS checks necessity of handover from the GERAN cell to the GAN cell.

A2. The source BSS determines it necessary to trigger the terminal in the DTM state to hand over to the GAN cell, and therefore, sends handover preparation request information of the CS domain and PS domain to the GANC which serves as a handover target in order to prepare for the handover.

According to the existing system architecture, at the CS handover preparation stage, the relevant information is generally forwarded by a circuit switching service node such as Mobile Switching Center (MSC) in the CN. At the PS handover preparation stage, the relevant information is generally forwarded by a packet switching service node such as Serving General Packet Radio Service (GPRS) Support Node (SGSN) in the CN; the GANC may use an interface that is the same as the interface of the BSS and connected with the CN, for example, A-interface, and Gb interface. Therefore, the MSC and SGSN may forward the information at the handover preparation stage like performing DTM handover in the GERAN.

A3. According to the received handover preparation request information, the GANC creates user data links applicable to the CS domain and PS domain for the terminal, and returns the handover preparation result information to the source BSS.

In the handover preparation process, the handover preparation request information of the CS domain and PS domain may be forwarded by two devices of the CN respectively. Therefore, the GANC may apply different policies to procedure such information. This embodiment provides the following three processing modes:

(i) The target GANC allocates the resources according to the corresponding handover preparation request information. That is, upon receiving the handover preparation request information of the CS domain, the target GANC creates the user data link applicable to the CS domain for the terminal, for example, implements the GA-CSR connection creation procedure to create a GA-CSR connection for the terminal; upon receiving the handover preparation request information of the PS domain, the target GANC creates the user data link applicable to the PS domain for the terminal, for example, implements the GA-PSR transport channel activation procedure to create a GA-PSR transport channel for the terminal. For the purpose of simplicity, the user data links created by the GANC for the same terminal and applicable to the CS domain and PS domain are collectively called a Generic Access Resource Control Dual Transfer Mode (GA-RC DTM) channel.

(ii) When the source BSS initiates DTM handover, the sent handover preparation request information of the CS domain and PS domain carries an identifier of DTM handover. Therefore, the target GANC also applies such a policy. That is, after receiving any handover preparation request information, the target GANC regards the current handover as DTM handover only if determining that the handover preparation request information carries a DTM handover identifier, and therefore, creates a GA-RC DTM channel for the corresponding terminal. Specifically, the GA-RC DTM channel may be created sequentially as described in mode (i); or the GANC uses a procedure to create the CS and PS traffic channels concurrently and create a GA-RC DTM channel for the terminal.

(iii) The target GANC may also apply this policy: After receiving a CS or PS domain handover preparation request that carries a DTM handover identifier, the target GANC regards the current handover as a DTM handover, and needs to wait for another handover preparation request related to the same terminal. After receiving the two handover preparation requests, the target GANC creates the GA-RC DTM channel. The waiting procedure may be monitored through a timer. If either of the handover preparation requests is not received upon timeout of the timer, the target GANC may choose to continue or cancel the handover.

After creating the GA-RC DTM channel, the target GANC sends handover preparation result information of the CS domain and PS domain to the source BSS, indicating completion of the handover preparation stage. The handover preparation result information of the CS domain and PS domain may carry a DTM handover identifier, and may be forwarded through an MSC and SGSN respectively.

A4. The source BSS sends a handover command to the terminal according to the handover preparation result information returned by the target GANC.

The terminal may know the information required for performing DTM handover through the system message released by the GANC when being registered onto the GAN cell, where the information includes cell identifier and routing area identifier or location area identifier, without using the radio channel information of the GERAN. Therefore, it does not matter whether the handover command delivered by the BSS carries radio channel information and optional cells or not, which is not restricted by this embodiment.

A5. The terminal performs handover to the target GANC according to the handover command delivered by the source BSS. The CS service and PS service are handed over to the existing GA-RC DTM channel of the target GANC, and data is received and transmitted through the GA-RC DTM channel.

During or after handover to the GANC, the terminal changes to the GAN working mode and maintains the Radio Resource (RR) layer of the CS domain and PS domain, for example, GA-CSR layer and GA-PSR layer. In the CS domain, the serving RR layer that provides the radio resource service changes to the GA-CSR layer, and activates the Service Access Point (SAP) between the Mobility Management (MM) layer and the GA-CSR layer, whereupon the GA-CSR state changes to a GA-CSR-DEDICATED state. In the PS domain, the GA-PSR obtains the control rights over the GPRS radio link layer of Radio Link Control (RLC) and over all GPRS Mobility Management Radio Resource Service Access Points (GMMRR SAPs), and the GA-PSR state changes to a GA-PSR-ACTIVE state. After completion of the foregoing change in the CS domain and PS domain, the terminal enters the GA-RC DTM state.

Besides, by reference to the handover procedure in the prior art, the following operations may be performed after successful handover of the terminal:

A6. The terminal sends a handover success message to the target GANC, where the message may carry location area/routing area update information; and

A7. After receiving the handover success message from the terminal, the target GANC sends a location area update request to the MSC, and sends a routing area update request to the SGSN. The MSC and SGSN notify the source BSS to release the resources corresponding to the terminal which has handed over.

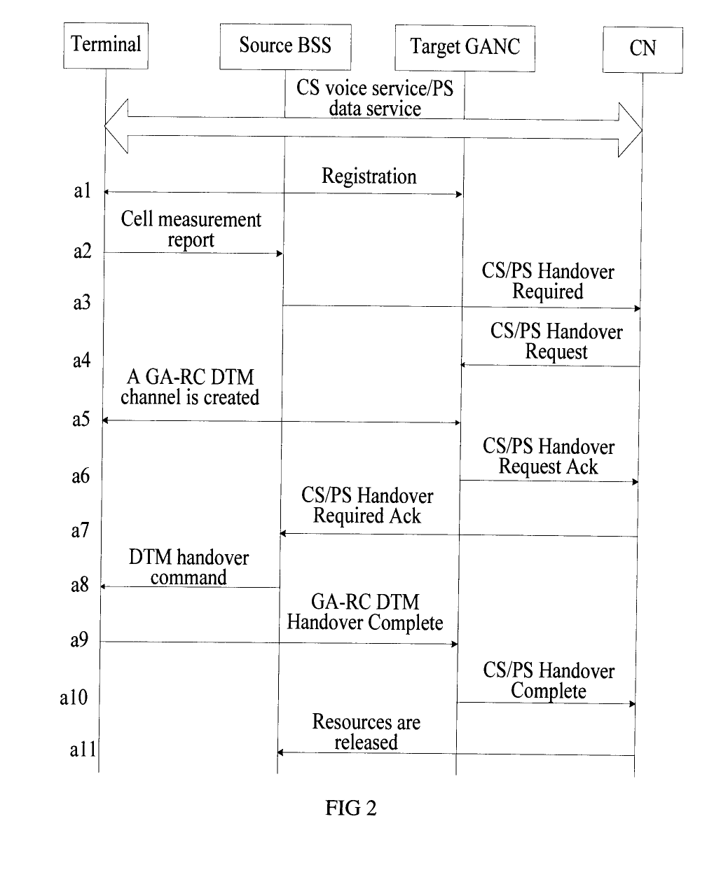

The foregoing signaling message between the terminal and the target GANC is transmitted through a TCP signaling channel between the terminal and the GANC. In order to make the method in this embodiment clearer, a signaling flow for implementing the method is given below. As shown in FIG. 2, the terminal in the DTM state in the GERAN is under a CS voice service and a PS data service concurrently. The handover procedure includes the following steps:

a1. The terminal is registered onto the target GANC.

In the registration procedure, the terminal may report its capability of supporting the GAN DTM handover through a Generic Access Resource Control (GA-RC) Register Request message, and the GANC indicates its capability of supporting the GAN DTM handover by delivering a GA-RC Register Accept message. The DTM handover to the GAN cell is performed only if both the GANC and the terminal support the GAN DTM handover.

a2. The terminal sends a cell measurement report to the source BSS, and sets the GAN cell as a best cell, where the report specifies the target GAN cell.

a3. The source BSS sends a CS Handover Required message and a PS Handover

Required message that carry handover preparation request information to the CN to require handover.

For simplicity, in FIG. 2, the MSC, SGSN, GPRS Gateway Supporting Node (GGSN), and other network elements are replaced by a CN, without drawing the signal transfer between the access network device and the MSC and SGSN. When the PS domain handover needs to be performed across the SGSN, the forwarded message may be forwarded through the GGSN to the SGSN where the target GANC is located, or sent directly from the source SGSN to the target SGSN, where the SGSN may be a 2G SGSN or 3G SGSN.

a4. The MSC and SGSN among the CN network elements send a CS Handover Request message and a PS Handover Request message that carry handover preparation request information to the target GANC, requesting to create a transport link.

a5. The target GANC creates a GA-RC DTM channel for the terminal, and creates CS and PS links connected to the CN.

a6. The target GANC sends a CS Handover Request Acknowledge message and a PS Handover Request Acknowledge message that carry handover preparation result information to the MSC and SGSN among the CN elements, indicating success of handover preparation. The Handover Request Acknowledge message may carry a Handover Reference value for identifying the Absolute Radio Frequency Channel Number (ARFCN) and Base transceiver Station Identity Code (BSIC) of the GAN cell.

a7. The MSC and SGSN among the CN network elements send a CS Handover Required Acknowledge message and a PS Handover Required Acknowledge message that carry handover preparation result information to the source BSS, indicating that a transport link has been created in the target GAN cell for the terminal.

a8. The source BSS sends a DTM Handover Command message carrying handover preparation result information to the terminal, commanding the terminal to hand over to the target GAN cell. The terminal may compare the ARFCN and BSIC in the handover command with the ARFCN and BSIC of the GANC where the terminal is currently registered. If the ARFCN and BSIC in the handover command are the same as the ARFCN and BSIC of the GANC where the terminal is currently registered, it indicates that the terminal is handing over to the correct GAN cell, and the terminal goes on with the handover; otherwise, the handover fails, and the terminal sends a handover failure command to the source BSS so that the source BSS cancels the handover.

a9. The terminal performs handover to the target GANC, changes to the GAN working mode, and uses the GA-CSR and GA-PSR and the SAP to receive and transmit user data and signaling, whereupon the terminal enters the GA-RC DTM state and sends a GA-RC DTM Handover Complete message to the target GANC. The message carries Location Area/Routing Area Update (LA/RA Update) information, for example, new routing area identifier and location area identifier, and new Packet Temporary Mobile Subscriber Identifier (P-TMSI) and Temporary Mobile Subscriber Identifier (TMSI).

The GA-RC DTM Handover Complete message carries the foregoing handover reference value. According to the handover reference value, the target GANC judges whether the terminal access is correct. The GANC may also make such judgment according to the TMSI or P-TMSI or IMSI of the terminal.

a10. The target GANC sends a CS Handover Complete message carrying LA Update information and sends a PS Handover Complete message carrying RA Update information to the MSC and SGSN among the CN elements. Meanwhile, using the LA/RA Update information in the GA-RC DTM Handover Complete message to perform the LA update procedure to the MSC and the RA update procedure to the SGSN; or perform a combined RA/LA update procedure. The LA/RA update may be performed by using the GA-RC DTM Handover Complete message.

a11. The MSC and SGSN among the CN network elements notify the source BSS to release resources. For example, in the CS domain, the MSC sends a Clear Command to let the source BSS release the CS resource; in the PS domain, the SGSN performs a Delete PFC procedure to let the source BSS release the PS resource. The handover procedure is ended.

### Embodiment 2

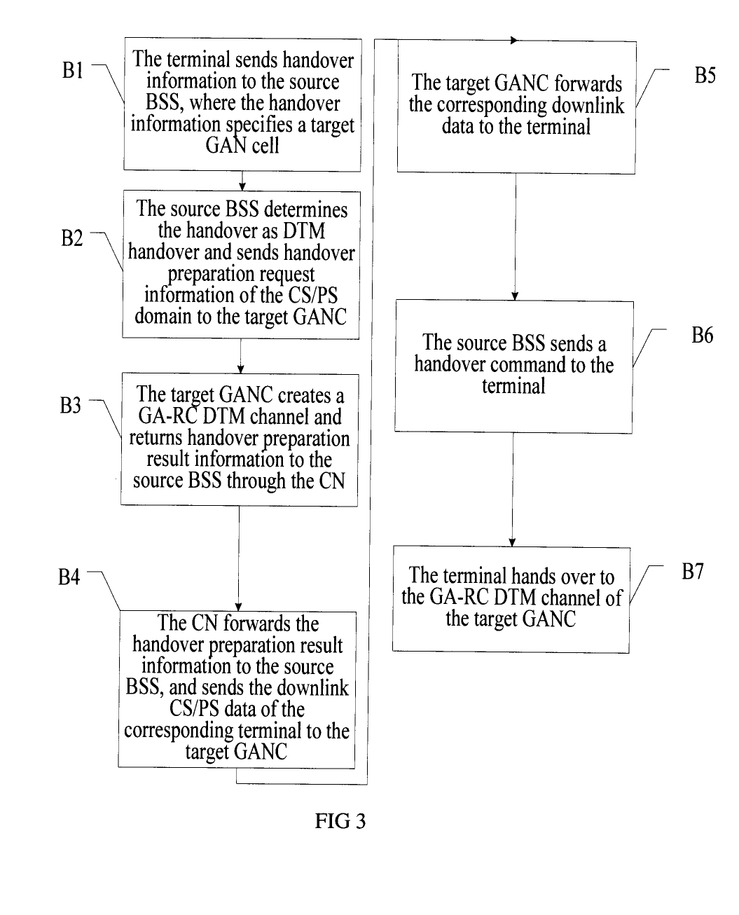

A method of DTM handover from other access networks to the GAN is provided herein. As shown in FIG. 3, this embodiment is the same as the first embodiment except that in this embodiment, the target GANC starts forwarding the service data as soon as possible after receiving the handover preparation request message. The procedure includes the following steps:

B1. The terminal sends handover information to the source BSS. The handover information specifies the target GAN cell of the handover.

B2. The source BSS determines that the terminal which initiates the handover is in the DTM state, and therefore, prepares for DTM handover, and sends handover preparation request information of the CS domain and PS domain to the target GANC through the MSC and SGSN, where the request information carries a DTM handover identifier.

B3. After receiving the handover preparation request information that is sent by the MSC or SGSN and carries the DTM handover identifier, the target GANC creates a GA-RC DTM channel for the terminal. After completion of creating the GA-RC DTM channel, the target GANC sends handover preparation result information of the CS domain and PS domain to the MSC and SGSN where the source BSS is located. After completion of creating the GA-RC DTM channel, the terminal is ready for receiving the CS and PS data.

B4. After receiving the handover preparation result information of the CS domain and PS domain, the MSC and SGSN starts sending the downlink CS and PS domain data of the corresponding terminal to the target GANC, and sends the handover preparation result information of the CS domain and PS domain to the source BSS.

Nevertheless, the reproduced forwarding mode may apply, namely, the same downlink data is also forwarded to the source BSS.

B5. The target GANC forwards the corresponding downlink data to the terminal on the GA-RC DTM channel created for the terminal.

The GANC forwards the downlink data upon completion of creating the GA-RC DTM channel. In this way, the service data may be sent to the terminal without waiting for completion of handover preparation of the CS domain and PS domain, thus reducing probability of data loss in the handover process, ensuring the QoS and improving the user experience.

B6. The source BSS sends a handover command to the terminal according to the handover preparation result information returned by the MSC and SGSN.

B7. The terminal sends and receives data on the traffic channel of the target GANC instead according to the handover command delivered by the BSS. In fact, at this time, it is possible that the terminal has been receiving data on the GA-RC DTM channel created by the target GANC.

The procedure after handover success is the same as that in the first embodiment, and is not repeated here any further.

### Embodiment 3

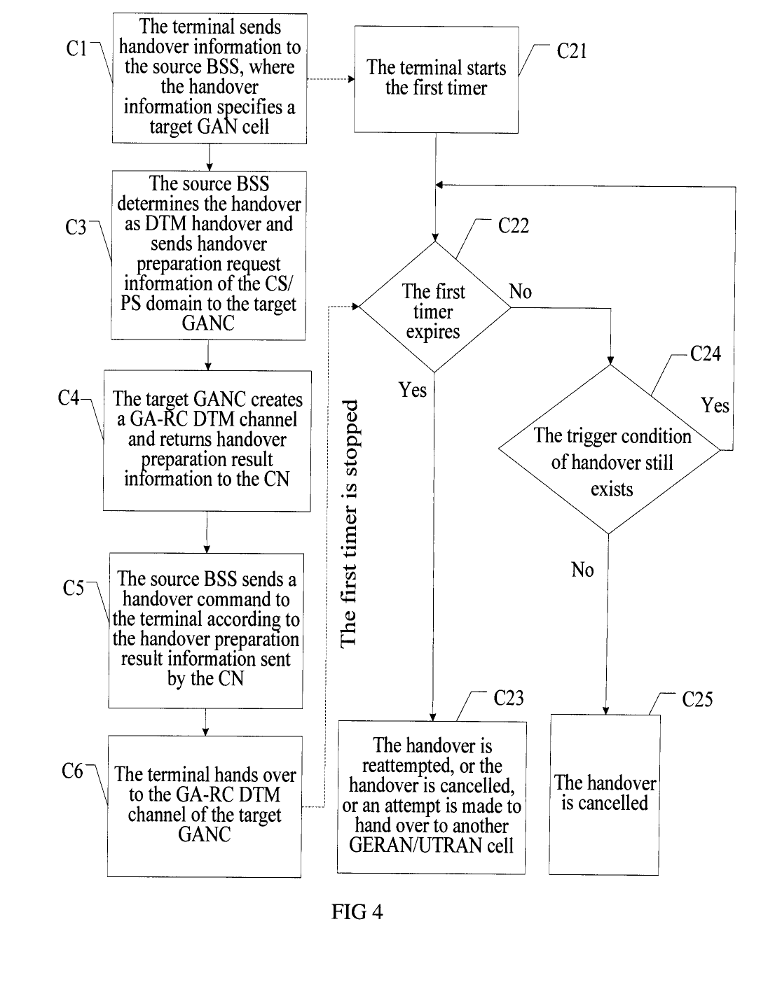

A method of DTM handover from another access network to a GAN is provided herein. As shown in FIG. 4, the procedure of this embodiment is almost the same as that in the first embodiment except that in this embodiment, the terminal not only performs the handover process, but also monitors timeout of the handover process and necessity of continuing the handover process. The procedure includes the following steps:

C1. The terminal sends handover information to the source BSS. The handover information specifies the target GAN cell of the handover.

C2. After triggering the handover, the terminal monitors the handover process through the first timer. The monitoring procedure includes:

C21. The terminal starts the first timer.

In practice, the first timer may be started before or after sending the handover information, or started at the same time of sending the handover information.

C22. In the subsequent handover process, the terminal monitors the handover process by checking timeout of the first timer. If no handover command is received from the network before timeout of the first timer, the handover is regarded as failed, and the procedure proceeds to step C23.

The setting of the terminal may be: The first timer is stopped upon receiving the handover command. Therefore, timeout of the first timer indicates that no handover command is received by the terminal from the network.

C23. The terminal may reattempt or cancel the handover. If the handover is triggered by quality deterioration of the current cell, handover to another GERAN cell may be attempted.

C24. In order to avoid exceptional round-trip handover between the cells due to transient faults, the terminal may judge whether the trigger condition of the handover is fulfilled during operation of the first timer. If the trigger condition is not fulfilled, the procedure proceeds to step C25.

The terminal may check non-fulfillment of the trigger condition of the handover anytime before timeout of the first timer. The judgment may be made repeatedly, and may be made before or after certain steps or periodically or triggered by relevant events, for example, arrival of a message or fulfillment of a predetermined network condition. The terminal may record the trigger condition of the handover at the beginning of the handover. In the subsequent judgment, the terminal needs only to judge whether the condition is still fulfilled.

C25. The terminal cancels the handover.

The terminal may send a handover cancellation message to the source BSS, and the BSS performs the procedure of canceling the handover, for example, notifies the target GANC to release the existing link.

C3. The source BSS determines that the terminal which initiates the handover is in the DTM state, and therefore, sends handover preparation request information of the CS domain and PS domain to the CN to prepare for the handover.

C4. After receiving the handover preparation request information of the CS domain and

PS domain from the CN, the target GANC creates a GA-RC DTM channel for the terminal, and returns handover preparation result information to the CN.

C5. The source BSS sends a handover command to the terminal according to the handover preparation result information sent by the CN.

C6. The terminal hands over to the GA-RC DTM channel of the target GANC according to the handover command delivered by the source BSS.

The procedure after handover success is the same as that in the first embodiment, and is not repeated here any further.

### Embodiment 4

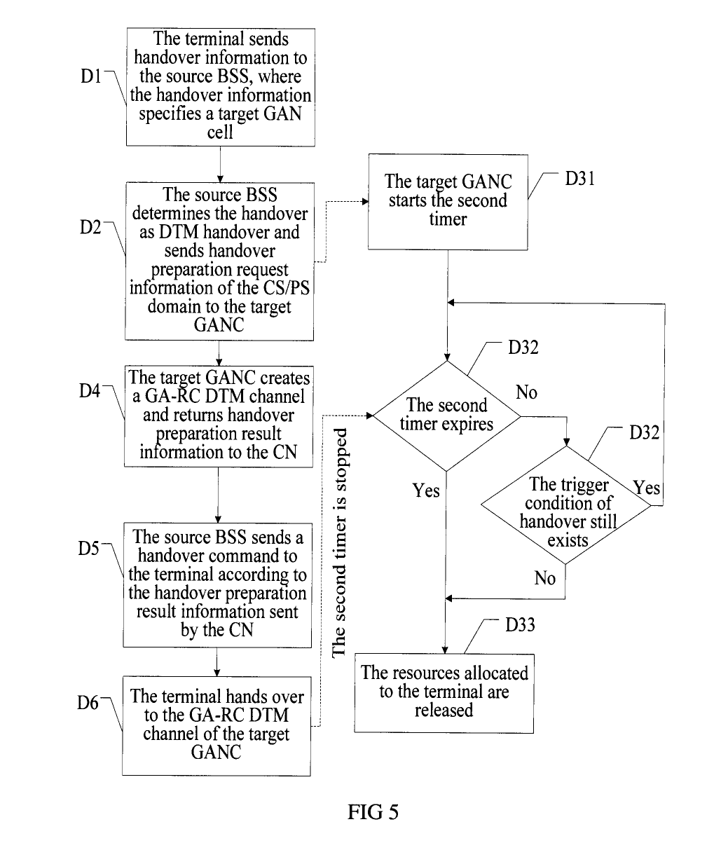

A method of DTM handover from another access network to a GAN is provided herein. As shown in FIG. 5, the procedure of this embodiment is almost the same as that in the first embodiment except that in this embodiment, the target GANC not only performs the handover process, but also monitors timeout of the handover process. The procedure includes the following steps:

D1. The terminal sends handover information to the source BSS. The handover information specifies the target GAN cell of the handover.

D2. The source BSS determines that the terminal which initiates the handover is in the DTM state, and therefore, sends handover preparation request information of the CS domain and PS domain to the CN.

D3. The target GANC uses the second timer to monitor the handover process after receiving the handover preparation request information of the CS domain and PS domain from the CN. The monitoring procedure includes the following steps:

D31. The target GANC starts the second timer for the handover.

Corresponding to the multiple occasions of creating the GA-RC DTM channel in the first embodiment, the target GANC can control the occasion of starting the second timer flexibly. The target GANC may start the second timer after receiving either or both of the handover preparation requests, and may start the second timer before or after creating the GA-RC DTM channel for the terminal. If the target GANC performs the handover process for multiple terminals concurrently, multiple timers may be started.

D32. In the subsequent handover process, the target GANC monitors the handover process by checking timeout of the second timer. If the terminal does not access the network successfully before timeout of the second timer, the handover is regarded as failed, and the procedure proceeds to step D33.

Generally, the GANC may check whether the terminal has accessed the network according to the message sent by the terminal, for example, the Handover Complete message sent by the terminal or the first user data packet of the CS domain or PS domain. The setting of the GANC may be: The second timer is stopped upon receiving the Handover Complete message. Therefore, timeout of the second timer indicates that the terminal still does not access the network successfully.

D33. The target GANC stops performing the handover process, releases the link created for the terminal, and may notify failure of the handover and causes for the failure to the source BSS.

D34. Like the scenario in the third embodiment, in order to avoid exceptional round-trip handover between the cells due to transient faults, the GANC may judge whether the trigger condition of the handover is fulfilled during operation of the second timer. If the trigger condition is not fulfilled, the handover may be cancelled and the procedure proceeds to step D33.

D4. The target GANC creates a GA-RC DTM channel for the terminal, and returns handover preparation result information of the CS domain and PS domain to the CN.

D5. The source BSS sends a handover command to the terminal according to the handover preparation result information returned by the CN.

D6. The terminal hands over to the GA-RC DTM channel of the target GANC according to the handover command delivered by the source BSS.

The procedure after handover success is the same as that in the first embodiment, and is not repeated here any further.

The foregoing second, third and fourth embodiments describe some preferred polices and control mechanisms in the process of handover from the GERAN to the GAN. In practice, the preferred solutions may be combined and collocated flexibly. For example, the monitoring mechanism of the terminal and the monitoring mechanism of the target GANC may be applied concurrently.

Detailed above is a method of handover into the GAN. Given below is an example of handover out of the GAN.

### Embodiment 5

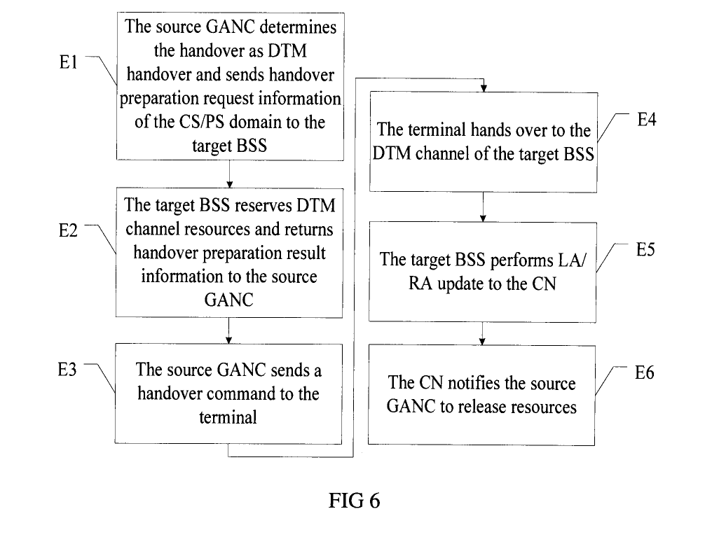

A method of DTM handover from a GAN to another access network is provided in this embodiment. This embodiment supposes that the other access network is a GERAN. As shown in FIG. 6, the procedure of the method includes the following steps:

E1. When the trigger condition of handover is fulfilled, the source GANC sends the handover preparation request information of the CS domain and PS domain to the BSS of the selected target RAN cell if the source GANC determines that a GA-RC DTM channel exists between the source GANC and the terminal and both the GANC and the MS support the GAN DTM handover.

In the GAN, the handover may be triggered by the GANC or terminal. This embodiment puts forward the following three triggering modes:

(i) The GANC measures the channel state of the CS domain and PS domain of the specified terminal. The channel state includes: bit error rate, delay, and system load. According to its own measurement results and system configuration (including GERAN or UTRAN cell configuration), the GANC initiates handover when the quality of the GA-RC DTM channel of the terminal deteriorates to a certain extent, and selects a target GERAN cell directly for handover. After the handover is initiated, the GANC may notify the terminal or not. If the GANC does not notify the terminal, the terminal receives the handover command of the GANC only after completion of the handover preparation, and performs the handover directly.

(ii) The handover may also be triggered by the terminal. Through local measurement, the terminal discovers that the GA-RC DTM channel connected to the GANC is deteriorated, and therefore, sends a Handover Information message as handover information to the GANC. According to the Handover Information message, the GANC sends handover preparation request information of the CS domain and PS domain to the core network. The Handover Information message may carry the GERAN cell information recently obtained from the GERAN network. The GANC selects the best cell as a RAN cell of the handover target, for example, according to the cell quality or system configuration principles.

The motion scope of the terminal in the GAN may be wide, for example, after relocation is performed. Therefore, the last obtained GERAN/URAN state may be not suitable for the current handover requirements. In order to improve the handover efficiency, the Handover Information message may carry no cell information, or an indication is sent to the GANC so that the GANC selects a proper target cell for handover. In this case, the GANC may select the target cell according to the system configuration of other preset peripheral RAT cells. For example, the GANC may configure the corresponding relation between all Access Points (APs) of the Wireless Local Area Network (WLAN) and other RAT cells, and each AP may correspond to one or more other RAT cells. The GANC may use an AP Identifier (AP-ID) to identify each AP. The AP-ID is a physical identifier of the terminal attachment point, for example, Medium Access Control (MAC) address. Through the attachment point, the terminal is connected to the universal IP network. After the GANC creates a corresponding relation between the AP-ID and other RAT cells, when it is necessary to select a target cell for a terminal, the GANC selects a proper cell as a target cell according to the AP-ID correlated with the current terminal and the foregoing relation between the AP and other RAT cells.

When the terminal is in the GAN cell, the terminal may use a receiver that supports other RAT cells to measure the radio environment of other peripheral access networks periodically, find peripheral radio cells supported by the terminal and store the found cells. The Handover Information message may carry the latest detected radio cells.

(iii) The handover may be triggered by the GANC, and the terminal makes the judgment. After discovering that the quality of the PS and/or CS link deteriorates to a certain extent, the GANC may send link quality indication information to the terminal, indicating the need of handover. The terminal sends a Handover Information message to the GANC according to the received link quality indication information.

The handover is performed in the PS domain and CS domain concurrently. Therefore, in modes (ii) and (iii), the terminal and GANC that trigger the handover may indicate the transport link of which domain is faulty through the sent handover information and link quality indication message, and receiver may judge whether to ignore the message without handover.

Alternatively, the method of triggering the handover in the CS domain and PS domain in the system based on the prior art may apply. In modes (ii) and (iii), the GA-CSR or GA-PSR layer on the terminal or GANC initiates the handover. The CS or PS Handover Information message sent by the terminal and the CS or PS link quality indication information sent by the GANC carries the DTM handover indication, indicating the need of DTM handover. After receiving any Handover Information message that carries the DTM handover indication, the GANC triggers the DTM handover.

Like the scenario in the first embodiment, the CS domain or PS domain handover preparation request information sent by the source GANC may be forwarded by the CN to the target BSS to let the target BSS reserve the resources. The CS/PS handover preparation request information may carry a DTM handover identifier to indicate that the handover is a DTM handover.

In the handover process, namely, after the handover is triggered and before the handover is completed or cancelled, neither the terminal nor the GANC releases the link of the CS or PS domain. For example, the release procedure is not triggered, or no response is made to the release request message, or the release request message is rejected.

E2. After receiving the handover preparation request information sent by the CN, the target BSS reserves DTM channel resources for the terminal, and returns handover preparation result information of the CS domain or PS domain to the source GANC. The handover preparation result information of the CS domain or PS domain may carry a DTM handover identifier.

Similarly, the handover preparation result information of the CS domain or PS domain may be forwarded by the CN to the GANC. This step is performed by the BSS according to the DTM handover process within the GERAN based on the prior art, and is not repeated here any further.

Besides, like the scenario in the second embodiment, after allocating the radio channel resources, the target BSS may deliver CS and PS service data or signaling on the channels. After receiving the handover preparation result information of the CS domain or PS domain, the CN may copy the CS and PS service data or signaling sent through the source GANC to the terminal, and send them through the target BSS over the channel allocated to the terminal.

E3. The source GANC sends a handover command to the terminal according to the received handover preparation result information.

The handover preparation result information carries the access information forwarded by the CN and required for handover from the terminal to the target BSS. The access information includes: radio resource description, power control parameter, carrier identifier, and handover reference value.

E4. The terminal hands over both the CS service and PS service to the DTM channel created by the target BSS according to the handover command of the GANC to perform service and signaling transmission.

If the terminal is handed over to a cell with a known Timing Advance (TA), it is not necessary to perform the access procedure, and the CS and PS services may be performed directly by using the radio resources allocated to the terminal. In this case, the terminal may receive the service data directly on the allocated traffic channel.

This step may be performed by reference to the terminal access procedure of the DTM handover within the GERAN.

Besides, by reference to the handover process in the prior art, the following operations may be performed after successful handover of the terminal:

E5. If the target BSS regards the handover as completed after receiving the LA/RA

Update message of the MS or receiving the voice/data sent by the MS correctly, the target BSS performs LA update to the MSC, performs RA update to the SGSN, or performs a combined RA/LA update procedure.

E6. The MSC and SGSN notify the source GANC to release the corresponding resources, and the handover process is completed.

After the terminal is handed over to the target BSS or at the same time of handover, or after the link between the terminal and GANC is released or at the same time of link release, the terminal changes to the GERAN or UTRAN working mode: In the CS domain, the serving Radio Resource (RR) layer that provides the radio resource service changes to the GSM RR layer, without using the SAP between the MM layer and the GA-CSR layer any longer, and the GA-CSR state changes to be invalid; in the PS domain, the serving RR changes to the GSM RR layer, and the GA-PSR layer is separated from all GPRS SAPs. The terminal may choose to be deregistered at the GANC. If the terminal is deregistered, the terminal state changes to the GA-RC De-Registered state, the terminal may change to the GA-RC De-Registered state without performing the deregistration procedure. If the terminal is not deregistered, the terminal state changes to the GA-RC Registered state, and maintains the signaling link with the GANC.

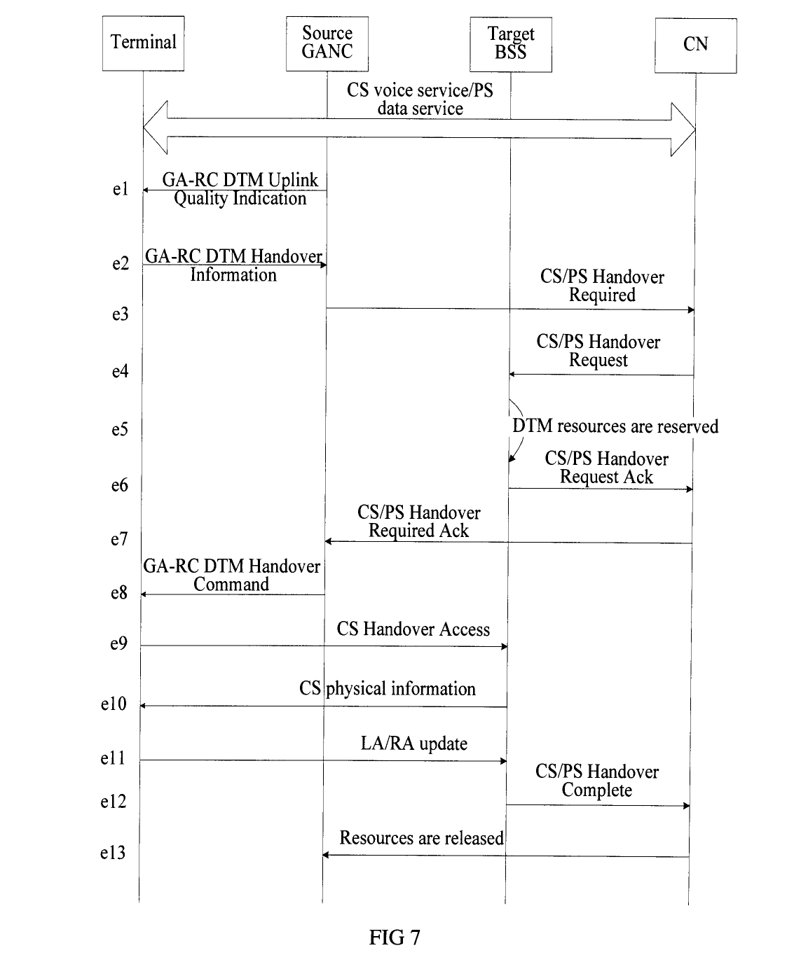

Generally, the foregoing signaling message between the terminal and the source GANC may be transmitted through the TCP signaling channel between the terminal and the GANC. In order to make the method in this embodiment clearer, a signaling flow for implementing the method is given below. As shown in FIG. 7, the terminal in the GA-RC DTM state in the GAN is under a CS voice service and a PS data service concurrently. The handover process includes the following steps:

e1. The source GANC sends a GA-RC DTM Uplink Quality Indication message to the terminal. The message indicates CS and/or PS uplink quality fault of the current GA-RC DTM channel, and triggers the handover.

The source GANC may also send a GA-CSR Uplink Quality Indication message to the terminal, where the message carries a PS Indicator. Alternatively, the source GANC may send a GA-PSR Uplink Quality Indication message, where the message carries a CS Indicator. The indicator in the message indicates the need of the DTM handover.

e2. The terminal sends a GA-RC DTM Handover Information message to the source GANC. The message carries a GERAN/UTRAN cell list as handover information, and the channel quality description of each cell. The GANC may select the cell of high channel quality as a target cell according to the receiving level strength of each GERAN cell in the report.

Accordingly, the terminal may also send a GA-CSR Handover Indication message to the GANC, where the message carries a PS Indicator. Alternatively, the terminal may send a GA-PSR Handover Information message, where the message carries a CS Indicator. The indicator in the message indicates the need of the DTM handover. If no indicator is carried, or the indicator indicates no need of DTM handover, the GANC initiates only the handover process of the corresponding domain.

In order to prevent the terminal from being unable to return to the source GAN cell normally after handover failure, the terminal does not release the CS or PS link (namely, the terminal does not trigger or perform the GA-CSR Connection Release procedure or GA-PSR Transport Channel Deactivation procedure) within a time period after sending the foregoing Handover Information message. For the GA-PSR transport channel, the GA-PSR Channel Timer corresponding to the channel may be stopped, or such a timer is restarted upon timeout to accomplish the foregoing purpose. For the release procedure triggered by the GANC, no response needs to be made, or the release procedure is rejected.

e3. The source GANC sends a CS Handover Required message and a PS Handover

Required message that carry handover preparation request information to the CN to request handover. The CS Handover Required message and the PS Handover Required message may indicate that the handover is DTM handover, namely, CS handover and PS handover are performed concurrently.

Like the scenario in FIG. 2, FIG. 7 also substitutes the CN for the MSC and SGSN or GGSN, without illustrating the signaling transfer between the access network device and the CN network element. The GANC may access the GGSN directly so that the packet transmission efficiency is higher.

e4. The CN sends a CS Handover Request message and a PS Handover Request message that carry handover preparation request information to the target BSS, requesting to reserve DTM resources.

When the GANC accesses the GGSN directly, the GANC may send the activated Packet Data Protocol (PDP) context list to the SGSN connected with the target BSS through a standard interface such as Gn interface. The PS handover request message may carry no Packet Flow Context (PFC) list. Therefore, after receiving the PDP context list from the source GANC, the SGSN of the target system may trigger creation of a PFC procedure before or after the sent PS handover request message arrives at the target BSS, and perform QoS negotiation.

e5. The target BSS performs DTM resource reservation for the MS, and organizes the handover preparation result information of the CS/PS domain.

e6. The target BSS sends a CS Handover Request Acknowledge message and a PS Handover Request Acknowledge message that carry handover preparation result information to the CN, indicating success of resource reservation.

e7. The CN sends a CS Handover Required Acknowledge message and a PS Handover

Required Acknowledge message that carry handover preparation result information to the source GANC, indicating to the source GANC that DTM resources has been allocated to the terminal in the target GERAN cell.

e8. The source GANC sends a GA-RC DTM Handover Command message to the terminal. A DTM Handover Command in the prior art may be encapsulated in the message, and the message includes the handover preparation result information of the target BSS, commanding the terminal to hand over to the target GERAN cell.

If the terminal does not know the TA value of the target cell, e9 and e10 need to be performed; otherwise, e9 and e10 do not need to be performed.

e9. The terminal sends Handover Access message of the CS domain to the target BSS.

e10. The target BSS sends Physical Information of the CS domain to the terminal, where the Physical Information carries the TA value of the target cell.

e11. The terminal uses the radio resources allocated by the target cell to the terminal, and sends an LA Update message and an RA Update message to the target BSS.

e12. The target BSS sends a CS Handover Complete message carrying LA Update information and sends a PS Handover Complete message carrying RA Update information to the CN to update the LA/RA.

e13. The CN notifies the source GANC to release the resources, and the handover procedure is ended.

In the specific implementation, the GANC may release the CS domain and PS domain respectively.

In the CS domain, the MSC sends a Clear Command to let the source GANC release the CS resources. After receiving the message, the GANC triggers a GA-CSR Connection Release procedure.

In the PS domain, the SGSN performs a procedure of deleting PFC to let the source GANC release the PS resource. Upon completion of deleting the PFC, the GANC triggers a GA-PSR Transport Channel Deactivation procedure.

Alternatively, after the GANC receives the Clear Command of the CS domain and the PFC of the PS is deleted, the GANC performs a GA-RC DTM Channel Release procedure to release the resources of the CS domain and PS domain concurrently.

1. The GANC sends a GA-RC DTM Channel Release Request message to the terminal, notifying the terminal to release the links of the CS domain and PS domain.

2. The terminal releases all channels, and then sends a GA-RC DTM Channel Release Acknowledge message to the GANC to confirm the release.

Nevertheless, a DTM channel release indication may be carried in the message of the GA-CSR Connection Release procedure or GA-PSR Transport Channel Deactivation procedure, and the DTM channel is released through a procedure.

Through the foregoing process, all channels between the terminal and the GANC are released, and the terminal returns to the GAN idle state and gets into the GERAN/UTRAN operation mode. The GA-CSR and GA-PSR are separated from the upper-layer protocol, without using the corresponding SAP any more.

### Embodiment 6

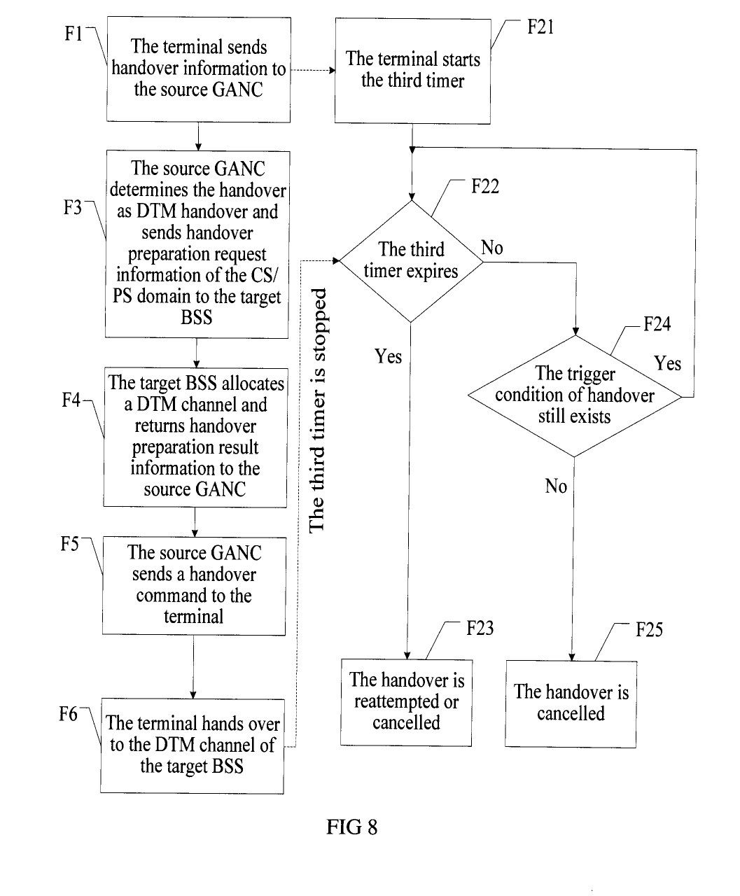

A method of DTM handover from a GAN to another access network is provided herein. As shown in FIG. 8, the procedure of this embodiment is almost the same as that in the fifth embodiment, and the handover triggering mode is the mode (ii) or (iii) in the fifth embodiment. The difference is: In this embodiment, the terminal not only performs the handover process, but also monitors timeout of the handover process and necessity of continuing the handover process. The procedure includes the following steps:

F1. The terminal sends handover information to the source GANC, and reports the GERAN cell information.

F2. After determining that the handover is initiated, the terminal uses a third timer to monitor the handover process. The specific monitoring process may be performed by reference to the third embodiment, and includes the following steps:

F21. The terminal starts the third timer.

F22. The settings of the terminal are: The third timer is stopped after the handover command is received; upon timeout of the third timer in the subsequent handover process, the terminal regards the handover as failed and the procedure proceeds to step F23.

F23. The terminal reattempts or cancels the handover.

F24. In order to avoid exceptional round-trip handover between the cells due to transient faults, the terminal may judge whether the trigger condition of the handover is fulfilled during operation of the third timer. If the trigger condition is not fulfilled, the procedure proceeds to step F25.

In order to prevent the terminal from being unable to return to the source GAN cell after handover failure, during operation of the third timer, the terminal makes no response or rejects if receiving a GA-CSR Release message or GA-PSR-DEACTIVATE-UTC-REQ message. The terminal restarts the timer upon timeout of the GA-PSR channel timer, and does not send any GA-CSR CLEAR REQUEST or GA-PSR Transport Channel to release the traffic channel.

F25. The terminal cancels the handover without changing the state, and stays in the GAN cell.

The terminal may send a handover cancellation message to the source GANC, and the source GANC performs the procedure of canceling the handover, for example, notifies the target BSS to release the allocated resources.

F3. The source GANC determines that the terminal which initiates the handover is in the DTM state (namely, a GA-RC DTM Channel exists). Therefore, the source GANC selects a target GERAN cell from the GERAN cell information reported by the terminal, and sends handover preparation request information of the CS domain and PS domain to the CN to prepare for the DTM handover to the target BSS.

F4. After receiving the handover preparation request information forwarded by the CN, the target BSS allocates a DTM channel to the terminal, and returns handover preparation result information to the source GANC through the CN.

F5. The source GANC sends a handover command to the terminal according to the handover preparation result information returned by the CN.

F6. The terminal hands over to the target BSS according to the handover command delivered by the source GANC.

The procedure after handover success is the same as that in the fifth embodiment, and is not repeated here any further. The third timer used by the terminal in this embodiment may be the same as the first timer used by the terminal in the third embodiment.

### Embodiment 7

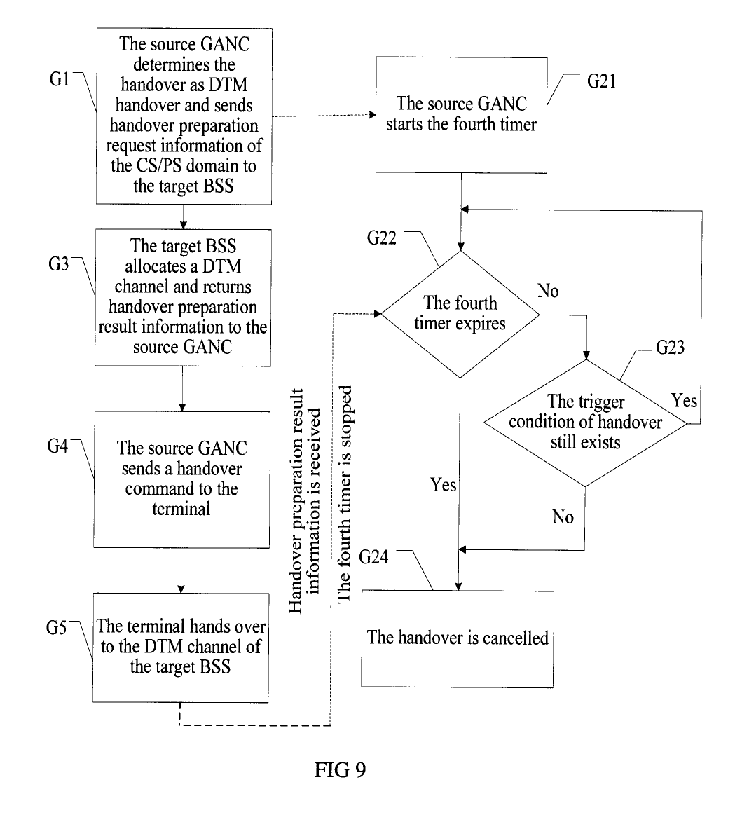

A method of DTM handover from a GAN to another access network is provided herein. As shown in FIG. 9, the procedure of this embodiment is almost the same as that in the fifth embodiment except that in this embodiment, the target GANC not only performs the handover process, but also monitors timeout of the handover process. The procedure includes the following steps:

G1. After the DTM handover is triggered, the source GANC sends handover preparation request information of the CS domain and PS domain to the CN, where the handover may be triggered in any of the three modes in the fifth embodiment.

G2. After determining that the handover is initiated, the source GANC monitors the handover process through the fourth timer. The monitoring procedure includes the following steps:

G21. The source GANC starts the fourth timer for the handover.

In order to prevent the terminal from being unable to return to the source GAN cell after handover failure, during operation of the fourth timer, the GANC does not trigger release of the traffic channel, or makes no response to or rejects the traffic channel release request. For example, the GANC does not send the GA-CSR Release message or GA-PSR-DEACTIVATE-UTC-REQ message; the GANC makes no response or rejects if receiving a GA-CSR CLEAR REQUEST or GA-PSR Transport Channel for releasing the traffic channel.

G22. The settings of the source GANC are: The fourth timer is stopped after the handover preparation result information of the CN is received or the handover cancellation message is received; upon timeout of the fourth timer in the subsequent handover process, the procedure proceeds to step G24.

G23. The GANC may check non-fulfillment of the trigger condition of the handover anytime before timeout of the fourth timer. The judgment may be made repeatedly, and may be made before or after certain steps or periodically or triggered by relevant events, for example, arrival of a message, and fulfillment of a preset network condition. The GANC may record the trigger condition of the handover at the beginning of the handover procedure. In the subsequent judgment, the GANC needs only to judge whether the condition is still fulfilled. If the GANC determines that the trigger condition of the handover is not fulfilled any longer, the procedure proceeds to step G24 to cancel the handover.

G24. The source GANC cancels the handover.

G3. After receiving the handover preparation request information forwarded by the CN, the target BSS allocates a DTM channel to the terminal, and returns handover preparation result information to the source GANC through the CN.

G4. The source GANC sends a handover command to the terminal according to the handover preparation result information returned by the CN.

G5. The terminal hands over to the target BSS according to the handover command delivered by the source GANC.

The procedure after handover success is the same as that in the fifth embodiment, and is not repeated here any further.

The foregoing sixth and seventh embodiments describe some preferred control mechanisms in the process of handover from the GAN to the GERAN. In practice, the preferred solutions may be combined and collocated flexibly. For example, the monitoring mechanism of the terminal and the monitoring mechanism of the source GANC may be applied concurrently.

Embodiments 1-7 are easily extensible so that the BSS may be replaced by the RNS or another corresponding network element/radio access system in the UTRAN, and the GANC is easily extensible so that the GANC may be connected to the radio core network through various interfaces such as A/Gb interface, Iu interface, or combination thereof. Further details are given in the following embodiment.

### Embodiment 8

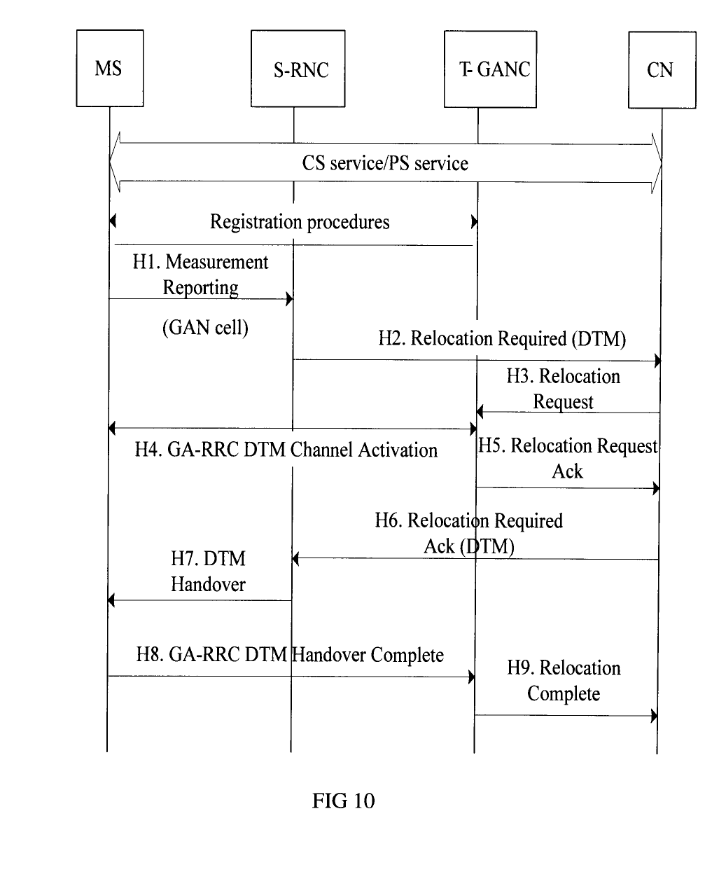

A method of DTM handover from another access network based on the RAT to the GAN is provided in this embodiment. The other access network may be a GERAN or UTRAN, and is supposed to be a UTRAN in this embodiment. The GANC accesses the radio core network through an Iu interface. As shown in FIG. 10, the procedure of the method includes the following steps:

H1. The terminal sends handover information to the source RNC. The handover information specifies the target GAN cell of the handover. For example, the handover information is a measurement report or cell change notification.

The discovery and registration of the GAN are similar to those in the first embodiment, and are not repeated here any further.

H2. The source RNC determines it necessary to trigger handover of the terminal in the DTM state to the GAN cell, and therefore, sends a Relocation Required message to the CN. The message carries the information about the CS relocation to the MSC and the information about the PS relocation to the SGSN, and specifies that the current handover is DTM handover.

H3. After receiving the Relocation Required message, the MSC and SGSN send a Relocation Request message to the GANC on the Iu interface so that the GANC prepares resources for the current DTM handover.

H4. After receiving the Relocation Request message from the MSC and SGSN, the GANC initiates setup of a GA-RC DTM channel, which bears both CS and PS services between the MS and GANC.

In order to support the DTM channel, when the Generic Access Radio Resource Control (GA-RRC) sublayer of the MS is in the GA-RRC-CONNECTED state, the CS domain and PS domain may have two different DTM sub-states.

(1) DTM-INACTIVE: This state is an initial state of the CS domain and PS domain when the GA-RRC sublayer of the MS is in the GA-RRC-CONNECTED state. When the CS domain and PS domain are in the DTM-INACTIVE state, the CS and PS channels do not exist between the MS and GANC simultaneously, and the CS and PS service data cannot be received or transmitted between the MS and GANC simultaneously. To perform CS and PS services simultaneously, it is necessary to activate at least one channel between the MS and GANC for the purpose of both CS and PS services, whereupon the DTM sub-state of the MS changes to the DTM-ACTIVE state.

(2) DTM-ACTIVE: This state is a state of the CS domain and PS domain when the GA-RRC sublayer of the MS is in the GA-RRC-CONNECTED state. When the CS domain and PS domain are in the DTM-ACTIVE state, at least one channel is available for the CS service and at least one channel is available for the PS service, and the CS and PS service data can be received and transmitted simultaneously. If neither CS channel nor PS channel exists, the CS domain and PS domain return to the DTM-INACTIVE state.

The foregoing GA-RRC sublayer refers to an entity responsible for the Up interface resource management in the protocol stack of the GAN Iu mode. The entity handles the resources of the CS domain and PS domain, and its functions are similar to the functions of the GA-RC or GA-CSR and GA-PSR in the GAN A/Gb mode.

First, the GA-RRC Connection Establishment procedure or other procedure needs to be performed between the MS and GANC, and a RAB signaling link is set up between the MS and GANC so that the MS is in the GA-RRC-CONNECTED/DTM-INACTIVE state.

According to the Relocation Request message sent by the MSC and SGSN, the GANC activates the CS bearer and PS bearer respectively. Alternatively, all required bearer channels (namely, at least one bearer channel for bearing CS services and at least one bearer channel for bearing PS services) are activated through one message.

H5. After the CS and PS bearer channels are allocated, the GANC sends a Relocation Request Ack message through an Iu interface to the MSC and SGSN to confirm that the DTM handover can be performed normally.

H6. After the MSC and SGSN receive the Relocation Request Ack message, it indicates that the resources are allocated in the CS domain and PS domain, and the handover can go on. Therefore, the MSC and SGSN send a Relocation Required Ack message to the source RNC, thus completing the handover preparation.

H7. After receiving all the Relocation Required Ack messages from the MSC and SGSN, the RNC hands over the MS to the target GANC, and sends a DTM Handover Command message to the MS. The message carries the information that requires the MS to hand over to the GAN Iu mode, and the information about the CS domain and PS domain that enter the GAN Iu mode. For example, the message carries a GAN cell identifier.

H8. After receiving the handover command, the MS accesses the GAN cell. After successful access, the MS sends a GA-RRC DTM Handover Complete message to the target GANC. At this time, the operation mode of the MS changes from the UTRAN operation mode to the GAN Iu operation mode. The resource management entity of the UTRAN (for example, UTRAN RRC in the CS domain, PDCP layer in the PS domain) changes to the inactive state, and the corresponding SAP is separated from the upper layer and does not provide services for the upper layer any more. The GA-RRC layer of the GAN Iu serves as a new radio resource management entity to provide services for the upper-layer protocol of the CS domain and PS domain of the GA-RRC. The corresponding SAP is activated, and the MS enters the DTM-ACTIVE state.

H9. After receiving the handover success message from the terminal, the target GANC sends a Handover Complete message such as Relocation Complete message to the MSC and SGSN respectively. The MSC and SGSN notify the source RNC to release the resources corresponding to the terminal that has handed over.

### Embodiment 9

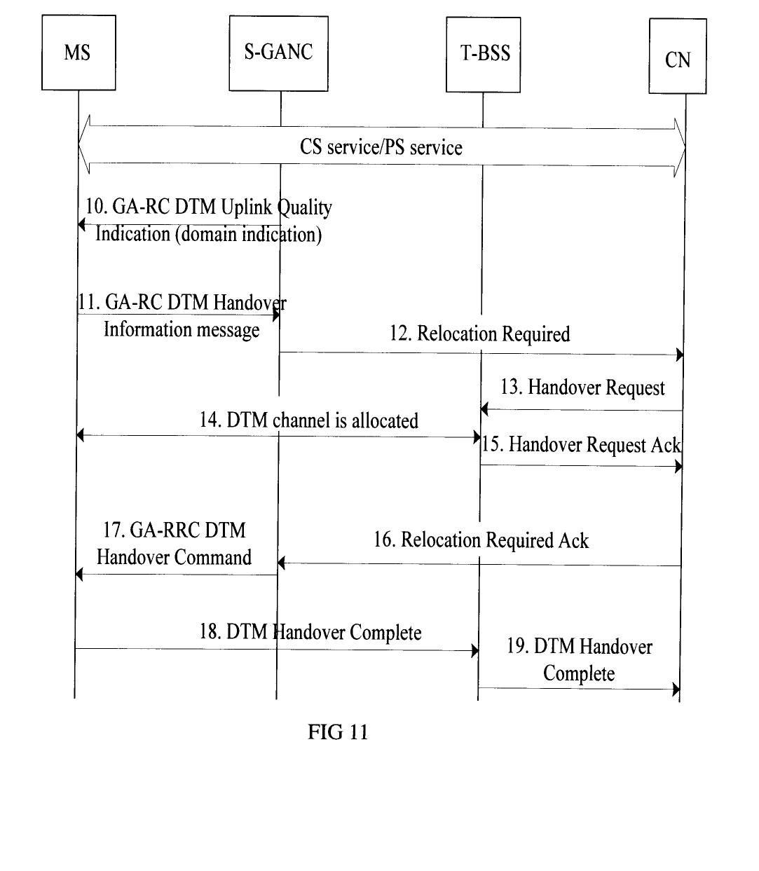

A method of DTM handover from a GAN Iu mode to another access network is provided in this embodiment. This embodiment supposes that the other access network is a GERAN. As shown in FIG. 11, the procedure of the method includes the following steps:

I0. The MS is registered in the GAN, and is performing the CS and PS services simultaneously. A channel bearer for the CS and PS services exists between the MS and the GANC, and a corresponding service context exists on the MS and GANC for describing the current service state. The MS is in the DTM-ACTIVE state. The GANC may send a GA-RRC DTM Uplink Quality Indication message to the MS, indicating that the quality of the current uplink channel is inferior. The message may carry domain information, and indicate which domain is problematic.

I1. After receiving the GA-RRC DTM Uplink Quality Indication message or finding that the downlink channel is problematic, the MS sends a GA-RRC DTM Handover Information message to notify the GANC to hand over. The message carries some candidate GERAN/UTRAN cells.

I2. When the source GANC decides to hand over the MS to the GERAN cell, if both the GANC and the MS support the GAN DTM handover, the source GANC initiates DTM relocation, sends the Relocation Required message of the CS domain through the Iu-cs interface to the MSC, and sends the Relocation Required message of the PS domain through the Iu-ps interface to the SGSN.

I3. After receiving the foregoing Relocation Required message, the MSC and SGSN assembles the message respectively, and sends a Handover Request message so that the target BSS allocates the corresponding resources for bearing the CS services and PS services. The MSC sends a Handover Request message of the CS domain to the BSS through an A-interface, and the SGSN sends a Handover Request message of the PS domain to the BSS through a Gb interface.

I4. After receiving all Handover Request messages from the MSC and SGSN, the BSS allocates the handover resources, and allocates the TBF to all PFCs required for the handover and allocates traffic channels to the CS calls required for the handover.

I5. If the BSS allocates the resources successfully, the BSS sends a Handover Request Acknowledge message to the MSC and SGSN through the A-interface, indicating that the handover may go on.

I6. The SGSN sends a Relocation Required Ack message to the source GANC through an Iu-ps interface, and the MSC sends a Relocation Required Ack message to the GANC through an Iu-cs interface, indicating completion of handover preparation.

I7. After receiving all the Relocation Required Ack messages from the MSC and SGSN, the source GANC delivers the channel resources included in the Relocation Required Ack message and allocated on the target BSS as well as the system message of accessing the target cell to the MS through a GA-RRC DTM Handover Command. Therefore, the MS hands over and accesses the target cell.

I8. After accessing target BSS cell successfully, the MS sends a Handover Complete message to the BSS. At this time, the operation mode of the MS changes from the GAN Iu operation mode to the GERAN operation mode. The GA-RRC layer entity of the GAN Iu changes to the inactive state, and the corresponding SAP is separated from the upper layer and does not provide services for the upper layer any longer. The MS gets out of the DTM-ACTIVE state. The GERAN RR layer serves as a new radio resource management entity to provide services for the upper-layer protocol of the CS domain and PS domain (for example, LLC layer of PS domain, MM layer of the CS domain), and the corresponding SAP is activated.

I9. After receiving the Handover Complete message, the BSS sends the Handover Complete message to the MSC and SGSN respectively, indicating success of the handover. Therefore, the MSC and SGSN release all relevant resources of the source GANC.

The GANC applicable to the foregoing embodiment is detailed below.

### Embodiment 10

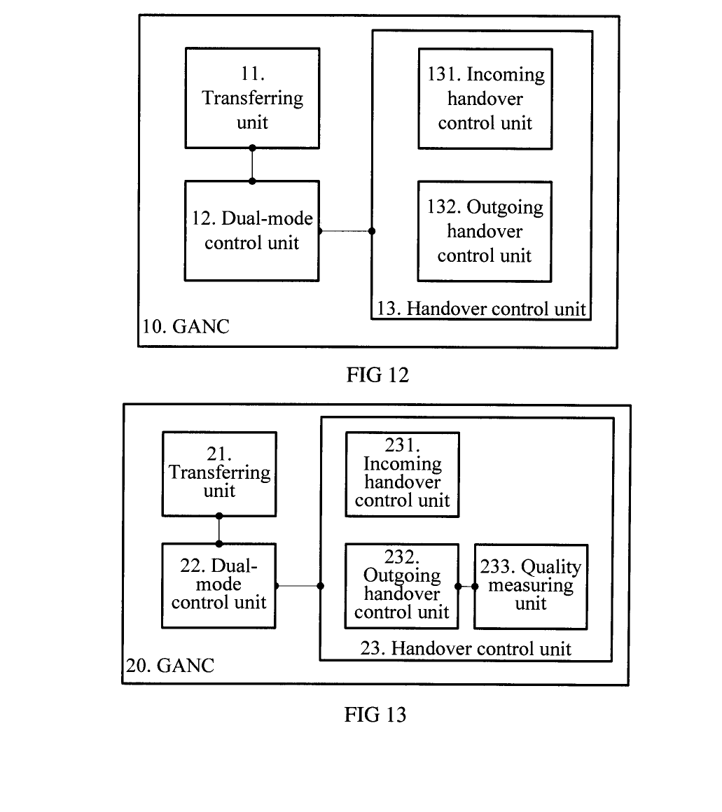

A GANC 12 is provided in this embodiment. As shown in FIG. 12, the GANC includes a transferring unit 11, a dual-mode control unit 12, and a handover control unit 13.

The transferring unit 11 is adapted to: provide a terminal with user data links applicable to the CS domain and PS domain, for example, GA-CSR Connection and GA-PSR Transport Channel; and receive and transmit the CS and PS user data.

The dual-mode control unit 12 is adapted to control the transferring unit 11 to create or release user data links applicable to the PS domain and CS domain for the same terminal according to the indication of the handover control unit 13.

The handover control unit 13 includes an incoming handover control unit 131 and an outgoing handover control unit 132.

The incoming handover control unit 131 is adapted to: handle the handover preparation request information of the PS domain and CS domain of the same terminal from the CN; instruct the dual-mode control unit 12 to create the user data links applicable to the PS domain and CS domain for the terminal; and return the handover preparation result information to the CN.

If the handover preparation request information of the CS domain and PS domain received by the incoming handover control unit 131 carries an identifier indicating that the terminal is in the DTM state, the incoming handover control unit 131 may apply this control policy:

After receiving either or both of the handover preparation request information of the CS domain and the handover preparation request information of the PS domain, the incoming handover control unit 131 instructs the dual-mode control unit 12 to create user data links applicable to the CS domain and PS domain for the terminal.

The outgoing handover control unit 132 is adapted to: judge whether the terminal stores the user data links applicable to both the CS domain and the PS domain; send the handover preparation request information of the CS domain and PS domain carrying a DTM handover identifier to the CN; receive the handover preparation result information returned by the CN; send a handover command to the terminal; and instruct the dual-mode control unit 12 to release the user data links applicable to the CS domain and PS domain and created for the terminal.

Through the GANC provided in the eighth embodiment of the present disclosure, a mobile terminal that performs the CS domain service and PS domain service concurrently may roam freely on a radio CN through different access technologies, thus improving the mobility and service experience of the users.

### Embodiment 11

A GANC 20 is provided herein. As shown in FIG. 13, when the GANC in this embodiment performs the DTM handover to other access networks, the first triggering mode provided in the fifth embodiment is applied.

A GANC 20 includes a transferring unit 21, a dual-mode control unit 22, and a handover control unit 23. The handover control unit 23 includes an incoming handover control unit 231, an outgoing handover control unit 232, and a quality measuring unit 233.

The transferring unit 21, dual-mode control unit 22, and incoming handover control unit 231 in this embodiment are similar to the transferring unit 11, dual-mode control unit 12, and incoming handover control unit 131 in the eighth embodiment, and are not repeated here any further.

The quality measuring unit 233 is adapted to: measure the quality of the local user data links applicable to the CS domain and PS domain; judge whether to initiate handover according to the measurement result; and select a RAN cell as a handover target according to the preset configuration for other RAN cells.

The outgoing handover control unit 232 is adapted to: judge whether the terminal stores the user data links applicable to both the CS domain and the PS domain according to the selection made by the quality measuring unit 232; send the handover preparation request information of the CS domain and PS domain carrying a DTM handover identifier to the CN; receive the handover preparation result information returned by the CN; send a handover command to the terminal; and instruct the dual-mode control unit 22 to release the user data links applicable to the CS domain and the PS domain and created for the terminal when necessary.

### Embodiment 12

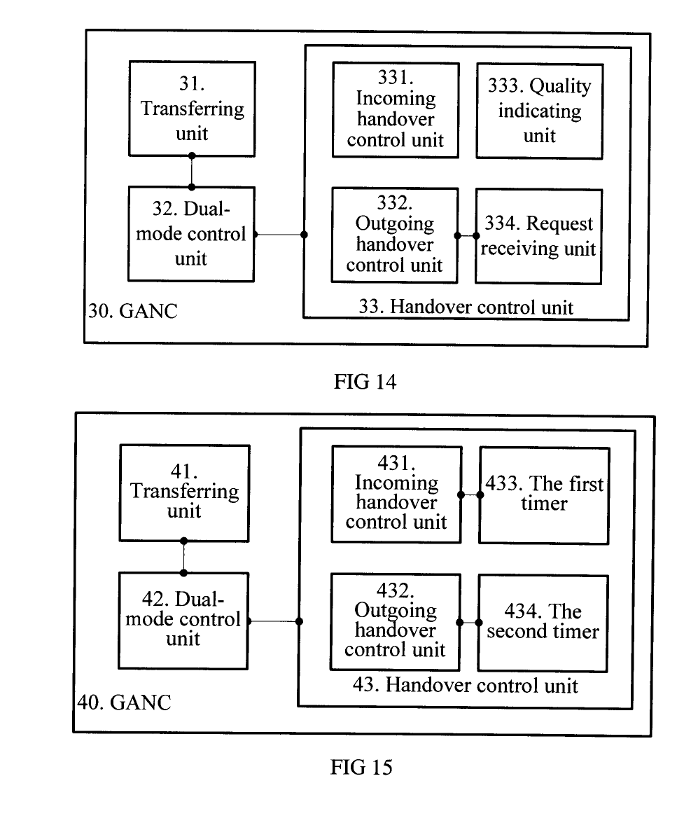

A GANC 30 is provided herein. As shown in FIG. 14, when the GANC in this embodiment performs the DTM handover to other access networks, the second and third triggering modes provided in the fifth embodiment are applied.

A GANC 30 includes a transferring unit 31, a dual-mode control unit 32, and a handover control unit 33. The handover control unit 33 includes an incoming handover control unit 331, an outgoing handover control unit 332, a quality indicating unit 333, and a request receiving unit 334.

The transferring unit 31, dual-mode control unit 32, and incoming handover control unit 331 in this embodiment are similar to the transferring unit 11, dual-mode control unit 12, and incoming handover control unit 131 in the eighth embodiment, and are not repeated here any further.

The quality indicating unit 333 is adapted to send link quality indication information to the terminal to indicate the necessity of handover.

The request receiving unit 334 is adapted to receive the Handover Information message from the terminal. The Handover Information message may be sent by the terminal proactively, or carried in the link quality indication information returned by the terminal to the quality indicating unit 333.

The outgoing handover control unit 332 is adapted to: judge whether the terminal stores the user data links applicable to both the CS domain and the PS domain according to the Handover Information message received by the request receiving unit 334; send the handover preparation request information of the CS domain and PS domain carrying a DTM handover identifier to the CN; receive the handover preparation result information returned by the CN; send a handover command to the terminal; and instruct the dual-mode control unit 32 to release the user data links applicable to the CS domain and PS domain and created for the terminal when necessary.

### Embodiment 13

A GANC 40 is provided in this embodiment. As shown in FIG. 15, during the DTM handover, the GANC in this embodiment may monitor the procedure of handover into the cell and the procedure of handover out of the cell. The capability of monitoring the procedure of handover into the cell may be set independently of the capability of monitoring the procedure of handover out of the cell.

A GANC 40 includes a transferring unit 41, a dual-mode control unit 42, and a handover control unit 43. The handover control unit 43 includes an incoming handover control unit 431, an outgoing handover control unit 432, a first timer 433, and a second timer 434. The transferring unit 41 and the dual-mode control unit 42 in this embodiment are similar to the transferring unit 11 and the dual-mode control unit 12 in the eighth embodiment, and are not repeated here any further.

The incoming handover control unit 431 is adapted to: handle the handover preparation request information applicable to the CS domain and PS domain of the same terminal and sent by the CN; start the first timer 433 after receiving the handover preparation request information; instruct the dual-mode control unit 12 to create user data links applicable to the CS domain and PS domain for the terminal; return handover preparation result information to the CN; detect whether the factors that trigger the handover still exist during operation of the first timer 433; cancel the handover if the factors that trigger the handover do not exist any longer; stop the first timer 433 upon receiving the access information of the terminal; if the first timer 433 expires but the terminal still fails to access the network, instruct the dual-mode control unit 12 to release the link created for the terminal, and send a notification through the CN to the source RAN that initiates the handover.

The outgoing handover control unit 432 is adapted to: judge whether the terminal stores the user data links applicable to both the CS domain and the PS domain, send the handover preparation request information of the CS domain and PS domain to the CN, and start the timer 434; receive the handover preparation result information returned by the CN, and send a handover command to the terminal; instruct the dual-mode control unit 42 to release the user data links applicable to the CS domain and PS domain and created for the terminal when necessary; detect whether the factors that trigger the handover still exist during operation of the second timer 434; cancel the handover if the factors that trigger the handover do not exist any longer; stop the second timer 434 upon receiving the handover preparation result information or sending the handover command; if the second timer 434 expires, cancel the handover or hand over to other RAT cells.

In addition, a user terminal is provided in some embodiments. The user terminal includes:

a handover information sending unit, adapted to send handover information to the network, where the handover information specifies the candidate target GAN cell or carries information on other RAN cells or carries a cell selection indication;

a command receiving unit, adapted to receive the handover command from the network; and

a handover unit, adapted to hand over the PS domain service and CS domain service to the created user data links according to the handover command.

Preferably, the terminal may further include: a capability negotiating unit, adapted to negotiate with the target GANC about the capability of supporting the DTM handover before the handover information is sent.

Preferably, the handover unit includes:

a command executing module, adapted to execute the handover command to change the working mode, for example, change from the source RAN working mode to the GAN working mode, or change from the source GAN working mode to the target cell RAN working mode;

an activating module, adapted to: activate the SAP between the resource management entity of the access network (for example, GAN or GERAN or UTRAN) of the target cell and the upper-layer protocol applicable to the CS domain and PS domain, and use the resource management entity of the access network (for example, GAN or GERAN or UTRAN) of the target cell as a new serving RR layer; and

a handover module, adapted to: operate the resource management entities of the access network (for example, GAN or GERAN or UTRAN) in the target cell of the CS domain and PS domain simultaneously, transmit the CS domain and PS domain user data and signaling, and make the access network (for example, GAN or GERAN or UTRAN) in the target cell enter the DTM mode.

In the embodiments described above, a mobile terminal that performs the CS domain service and PS domain service concurrently may roam freely on a radio CN through different access technologies, thus improving the mobility and service experience of the users. Moreover, various preferred solutions and control policies provided in the foregoing embodiments make the handover method more reliable and efficient.

Detailed above are a DTM handover method and a GANC consistent with the disclosed embodiments. Although the disclosure is described through some exemplary embodiments, the disclosure is not limited to such embodiments. It is apparent that those skilled in the art can make various modifications and variations to the embodiments without departing from the spirit and scope of the disclosure. The disclosure is intended to cover the modifications and variations provided that they fall in the scope of protection defined by the following claims or their equivalents.

What is claimed is:

1. A method for Dual Transfer Mode (DTM) handover, comprising:
receiving, handover information from a terminal in a DTM mode, wherein the handover information specifies a target Generic Access Network (GAN) cell;
sending, handover preparation request information of a Packet Switched (PS) domain and a Circuit Switched (CS) domain to the target GAN cell;
receiving, handover preparation result information of the PS domain and the CS domain from the target GAN cell in response to the handover preparation request information; and
sending, a handover command to the terminal.

2. The method of claim 1, further comprising:
creating, by the target GAN cell, a user data link applicable to the CS domain and the PS domain for the terminal in response to the handover preparation request information.

3. The method of claim 2, further comprising:
handing over, by the terminal, a CS domain service and a PS domain service to the user data link applicable to the CS domain and the PS domain respectively in response to the handover command.

4. The method of claim 1, wherein:
the handover information comprises a cell measurement report; and
the method further comprises:
determining, by a source Base Station Subsystem (BSS), to trigger the terminal to hand over from a Radio Access Technology (RAT) cell where the terminal is located to the target GAN cell by using the measurement report.

5. A method for Dual Transfer Mode (DTM) handover, comprising:
receiving, handover preparation request information of a Packet Switched (PS) domain and a Circuit Switched (CS) domain for a terminal from a source Radio Access Technology (RAT) cell where the terminal is located;
creating, by a Generic Access Network (GAN) cell, a user data link applicable to the CS domain and the PS domain for the terminal in response to the handover preparation request information; and
sending, by the Generic Access Network (GAN) cell, handover preparation result information of the PS domain and the CS domain for the terminal to the source RAT cell.

6. The method of claim 5, further comprising:
handing over, by the terminal, a CS domain service and a PS domain service to the user data link applicable to the CS domain and the PS domain respectively in response to a handover command, wherein the handover command is sent by the source RAT cell after receiving the handover preparation result information.

7. A method for Dual Transfer Mode (DTM) handover, comprising:
sending, by a Generic Access Network Controller (GANC) handover preparation request information of a Packet Switched (PS) domain and a Circuit Switched (CS) domain to a Radio Access Network (RAN) where at least one selected target cell is located when it is necessary to perform PS domain and CS domain handover for a terminal;
receiving, by the GANC, handover preparation result information from the RAN; and
sending a handover command to the terminal in response to the handover preparation result information.

8. The method of claim 7, further comprising:
creating, by the RAN, a user data link applicable to the PS domain and the CS domain for the terminal in response to the handover preparation request information.

9. The method of claim 8, further comprising:
handing over, by the terminal, a CS domain service and a PS domain service to the user data link applicable to the CS domain and the PS domain in response to the handover command from the GANC.

10. The method of claim 7, further comprising:
the terminal and the GANC notifying each other about capability of supporting DTM handover before the handover.

11. The method of claim 7, wherein before the GANC sends the handover preparation request information of the PS domain and the CS domain to the RAN the method further comprises:
sending, by the terminal, handover information to the GANC, wherein the handover information carries RAN cell information or a cell selection indication.

12. The method of claim 11, wherein before the terminal sends the handover information, the method further comprises:
sending, by the GANC, link quality indication information to the terminal to indicate to perform DTM handover.

13. A Generic Access Network Controller (GANC) comprising:
a transferring unit, adapted to provide a terminal with a user data link applicable to a Circuit Switched (CS) domain and a Packet Switched (PS) domain;
a dual-mode control unit, adapted to control the transferring unit to create or release the user data link applicable to the PS domain and the CS domain for the same terminal according to an indication of a handover control unit; and
the handover control unit, comprising an incoming handover control unit and an outgoing handover control unit, wherein:
the incoming handover control unit is adapted to: receive handover preparation request information of the PS domain and the CS domain of the same terminal from a Core Network (CN); instruct the dual-mode control unit to create the user data link applicable to the PS domain and the CS domain for the terminal; and return handover preparation result information to the CN; and
the outgoing handover control unit (132) is adapted to: send the handover preparation request information of the PS domain and the CS domain to the CN when the terminal needs to perform PS domain and CS domain handover; and receive the handover preparation result information returned by the CN, and send a handover command to the terminal.

14. The GANC of claim 13, wherein:
the handover control unit further comprises a request receiving unit, adapted to receive handover information sent by the terminal.

15. The GANC of claim 14, wherein:
the handover control unit further comprises a quality indicating unit, adapted to send link quality indication information to the terminal to indicate necessity of handover.

16. A user terminal, comprising:
a handover information sending unit, adapted to: send handover information to a network, wherein the handover information specifies a target cell;
a command receiving unit, adapted to receive a handover command from the network; and
a handover unit, adapted to hand over a Packet Switched (PS) domain service and a Circuit Switched (CS) domain service to a created user data link of the PS domain and the CS domain according to the handover command.

17. The user terminal of claim 16, further comprising:
a capability negotiating unit, adapted to negotiate with the network about capability of supporting Dual Transfer Mode (DTM) handover before handover information is sent.

18. The user terminal of claim 16, wherein the handover unit comprises:
a command executing module, adapted to: execute the handover command, and hand over a working mode to an access network working mode of the target cell;
an activating module, adapted to: activate a Service Access Point (SAP) between a resource management entity of the access network of the target cell and an upper-layer protocol applicable to the CS domain and the PS domain, and use the resource management entity of the access network of the target cell as a new serving Radio Resource (RR) layer; and
a handover module, adapted to: operate resource management entities of the access network in the target cell of the CS domain and the PS domain simultaneously, transmit user data and signaling of the CS domain and the PS domain, and make the access network in the target cell enter a Dual Transfer Mode (DTM) mode.
